(19) United States
(12) Patent Application Publication
(10) Pub. No.: US 2015/0371499 A1
(43) Pub. Date: Dec. 24, 2015

(54) ANACTIVITY INVITATIONPLATFORM FOR REAL-MONEY GAMING SYSTEMS

(71) Applicant: 3OAK Gaming Inc., Quebec (CA)

(72) Inventors: François Sansregret, Repentigny (CA); Mikael Lefebvre, Quebec (CA)

(21) Appl. No.: 14/738,080

(22) Filed: Jun. 12, 2015

Related U.S. Application Data
(60) Provisional application No. 62/013,886, filed on Jun. 18, 2014.

(51) Int. Cl. G07F 17/32

(52) U.S. Cl. CPC G07F 17/3244; G07F 17/3272; G07F 17/3204

(57) ABSTRACT

A gaming system having an activity invitation platform for integrating activity invitations in real-money gaming systems. The gaming system has a player database, an activity invitation platform and a real-money game application. The player database is adapted to store player game access control data, player game data and player profile data with respect to each players registered to play at least one real-money game with a player console via a network. The activity invitation platform is adapted to generate an activity invitation according to an invitation condition and at least one of the player game data and the player profile data. The real-money game application is adapted to execute the real-money game according to the activity invitation.

The present application claims priority of U.S. provisional patent application 62/013,886 filed Jun. 18, 2014.

### TECHNICAL FIELD

The present relates to a gaming system having an activity invitation platform for integrating activity invitations in real-money gaming systems. More particularly, the present relates to integrating activity invitations in real-money gaming systems according to an activity condition.

### BACKGROUND

Gambling establishments such as casinos, online casinos and online real-money game publishers all aspire to increase their level of game popularity towards players. It is known that an increase in popularity towards players will potentially drive an increase in revenue generated through players spending greater amounts of money in a game. Indeed such establishments use various mechanisms to promote their games in order to increase their number of players, motivate players to keep on playing for longer periods of time and encourage players to return repetitively.

U.S. Pat. No. 8,678,906 discloses a gaming system that provides to gaming establishments the flexibility to offer a collection game or persistence game to a plurality of players. The collection or persistence game is independently offered to players participating in a primary game or base game. This way, players may play at their favourite gaming machine and participate in a system wide collection game without leaving their primary game. The collection game is in a way part of a loyalty program that rewards players for playing at the primary games offered by the system.

The gaming system provides a collection game where players are brought to strategize for collecting elements in order to obtain a winning element combination. In one example, multiple players may work together or in teams to monitor the released elements, creating camaderie between players or have at least a perceived advantage by working together, if not an actual advantage. In another example, the gaming system provides the players a collecting game where each player has a unique game board and each player attempts to collect the winning element combination on their own.

Various types of collection games or persistence games are disclosed to reward the player. In one example the collection game involves collecting a plurality of elements (ex.: letters) in order to collect a winning element combination (ex.: letters to spell the word “vacation”). The collection game may be triggered randomly on upon an occurrence of an event to release one of the collectible elements to players. The gaming system repeats the process of releasing elements until one of the players collects all of the elements of the winning element combination. The first player to collect all of the elements of the winning collection combination wins a designated award or prize (ex.: a vacation to the Bahamas!). The gaming system can restrict players from collecting elements based on time intervals. In one example only one letter may be collected per day in order to motivate a player to return playing every day. In another example an element is released every thirty minutes but only enables a player to collect an element every sixty minutes, the player must therefore strategize when to collect an element in the sixty minute period and also keep on playing the game for a prolonged period of time. Moreover in some cases, the gaming system enables the player to play multiple collection games simultaneously. In one example, certain players, such as players having a higher ranking, may use a released element in any suitable collection game he is playing or may use a same released element in multiple collection games, this mechanism allows increasing player engagement towards the primary game.

Such gaming systems may increase a player's motivation to continue playing or return to play a game and also may increase the player's engagement towards a game. However, such systems do not motivate new players to join a game and do not motivate other players to continue playing or return to play a game. In addition, such systems do not allow increasing other player's engagement towards the game.

### SUMMARY

A player of a real-money game is likelier to spend an increased amount of money when he is motivated to play for a prolonged period of time, when he is motivated to return playing and when he is engaged towards the game. It has been discovered that by integrating activity invitations into real-money gambling games, motivation for game playing by all participating players can be increased. It has further been discovered that by integrating activity invitations into real-money gambling games, accomplishments of a single player can increase other player engagement towards the game. It has further been discovered that by integrating activity invitations into real-money gambling games, actions of a single player can increase other player motivation to continue playing or return playing.

In addition, it has further been discovered that lottery providers, game developers and game administrators prefer offering a real-money gambling game that has optional and adaptable activity invitations depending on a predetermined set of criteria. It has further been discovered that integration of such features into real-money gambling games is facilitated when lottery providers, game developers or game administrators can themselves add, remove or modify a feature in a real-money gambling game.

According to one aspect, there is real-money gaming system having a player database, an activity invitation platform and a real-money game application. The player database is adapted to store at least a player game access control data, a player game data and a player profile data with respect to each players registered to play at least one real-money game with a player console via a network. The activity invitation platform is adapted to generate an activity invitation according to an invitation condition and at least one of the player game data and the player profile data. The real-money game application is adapted to execute the real-money game according to the activity invitation.

According to yet another aspect, there is an activity invitation platform for receiving from a player database a player game data and a player profile data with respect to players registered to play at least one real-money game. The activity invitation platform is adapted to generate an activity invitation according to an invitation condition, the player game data and the player profile data, in order to allow a real-money game application to execute the at least one real-money game according to the activity invitation.

### BRIEF DESCRIPTION OF THE DRAWINGS

The invention will be better understood by way of the following detailed description of embodiments of the invention with reference to the appended drawings, in which:

FIG. 1A is a block diagram of an online real-money gaming system having an activity invitation platform connected to a player interface server, according to one embodiment;

FIG. 1B is a block diagram of an online real-money gaming system having real-money games installed on player consoles that are connected to an activity invitation platform, according to one embodiment;

FIG. 1C is a block diagram of an online real-money gaming system having an activity invitation platform that is integrated with a real-money game, according to one embodiment;

FIG. 2 is a block diagram of an online real-money gaming system having a activity invitation platform connected to a player interface server and an administrator interface server to allow controlling of an activity invitation, according to one embodiment;

FIG. 3 is a block diagram of development components for an online real-money gaming system, according to one embodiment;

FIG. 4A is a first screenshot of a battleship real-money game, according to one embodiment;

FIG. 4B is a second screenshot of the battleship real-money game of FIG. 4A, according to one embodiment;

FIG. 5 is a screenshot of a player progress map in a real-money game, according to one embodiment;

FIG. 6 is a screenshot of a collection library in a real-money game, according to one embodiment;

FIG. 7 is a screenshot of a collection library in a real-money game with friends requesting a gift, according to one embodiment;

FIG. 8 is a screenshot of achievement results associated to a real-money game for one player of the game, according to one embodiment;

FIG. 9 is a screenshot of a leader board associated to a real-money game, according to one embodiment and;

FIG. 10 is a screenshot of a daily spin wheel associated to a real-money game, according to one embodiment.

### DETAILED DESCRIPTION

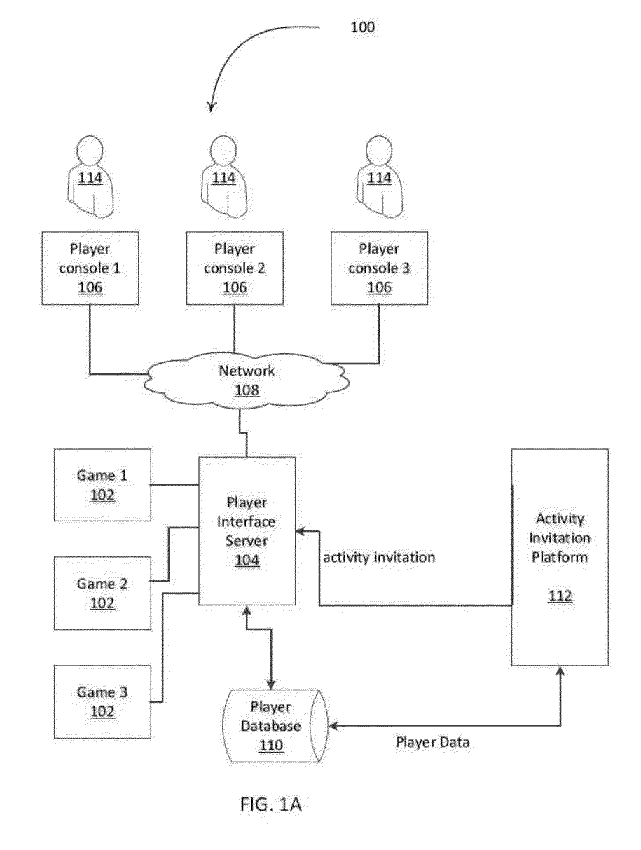

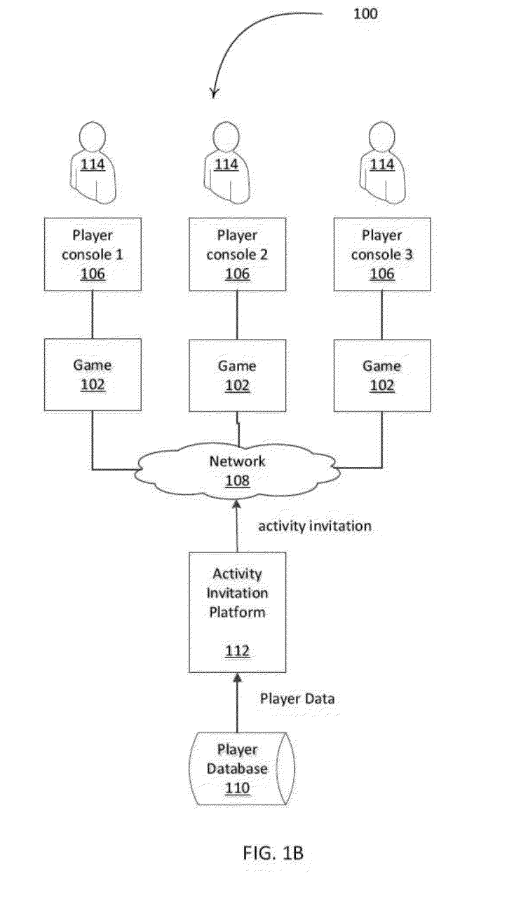

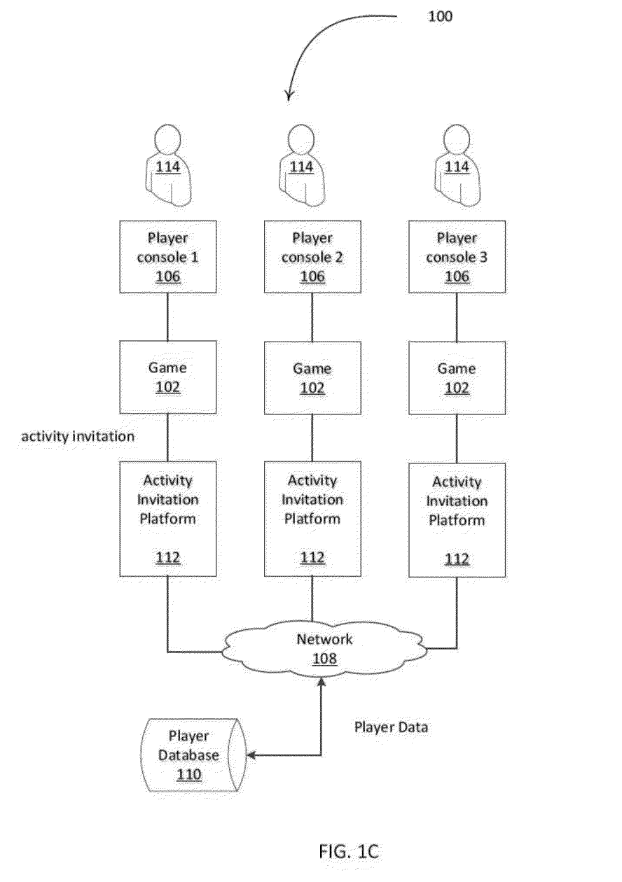

Presented in FIG. 1A, is an online real-money gaming system 100 that includes a variety of real-money games 102 each connected to a player interface server 104 for providing the real-money games 102 to player consoles 106 that are also connected to the player interface server 104 through a network 108. The player consoles 106 may be any suitable type of online connectable device such as a mobile phone, tablet, PC, slot cabinet, etc. The network 108 may be a local area network (LAN), a wide area network (WAN), an internet network or any other type of suitable network or combination thereof. The player interface server 104 is a portal to the games 102 and is adapted to communicate with a player database 110 in order to provide various player specific information such as player access control to the games 102, player profile data, player game data, etc.

According to one embodiment, player access control can include login information and/or game registration information that is specific to a player 114 of the console 106. Player profile data can include wallet information (i.e. real money, virtual money, virtual goods, etc.), social connection information (i.e. friends, player groups, etc.) that are specific to a player 114. Player game data can include achievement information in a game 102, score information in a game 102, status information in a game 102 (i.e. game level, game map, etc.), winnings information in a game 102 that are specific to a player 114.

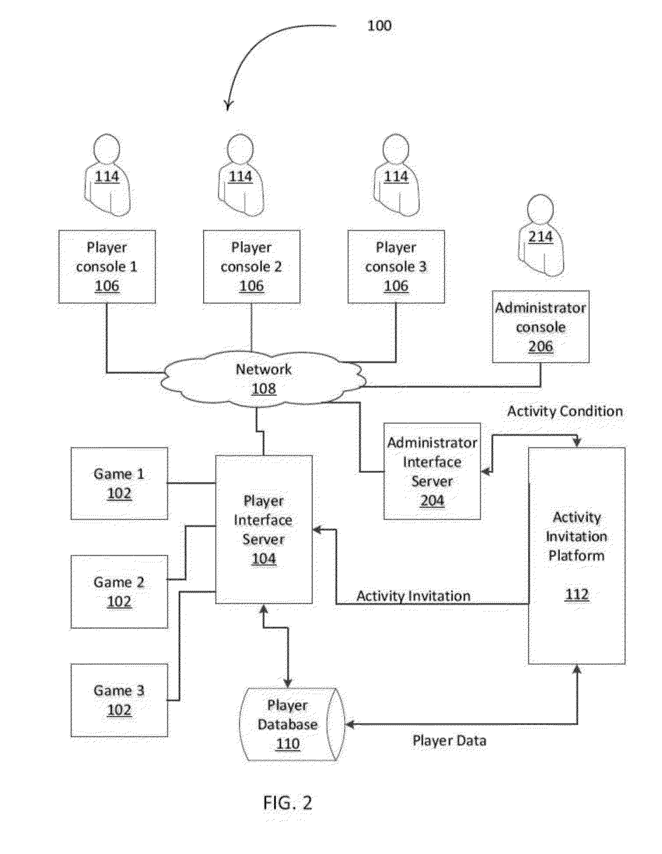

According to one aspect, as further presented in FIG. 1A, the system 100 includes an activity invitation platform 112. The activity invitation platform 112 is adapted to provide to a specific player 114 or group of players 114 an activity invitation via the player interface server 104 according to at least a player profile data or a player game data retrieved from the database 110. Various types of activity invitations may be provided based on a variety of activity conditions such as social conditions, gaming incentive conditions, or a combination thereof. A non-limiting list of social conditions relate to a multiplayer asynchronous game, a social game, a player game progress, a gift system and a leader board system. A non-limiting list of gaming incentive conditions relate to collection libraries, achievement rewards and daily spin rewards. As will be further explained, the activity condition may be a pre-set criteria in the activity invitation platform or a criteria that is set by a player 106 or an administrator 206, as presented in FIG. 2.

In FIG. 1A, the games are depicted as being remotely accessible by each player console 106. It shall be understood that as presented in FIG. 1B, the games 102 can instead be installed or partially installed on a player console 106, without departing from the scope of the present system. Moreover in FIG. 1A, the activity invitation platform 112 is depicted as being connected to the network via the player interface server 104. It shall be understood that as presented in FIG. 1B, the activity information platform 112 can be directly connected to the network, without departing from the scope of the present system.

It shall further be understood that as presented in FIG. 1C, the activity invitation platform 112 can be integrated or partially integrated in the game 102 whether the game is accessible via a network as in FIG. 1A or is locally installed as in FIG. 1B.

### Administrator Interface

According to one embodiment, as further presented in FIG. 2, the activity invitation platform 112 is adapted to control the activity invitation according to activity conditions received from and set by an administrator 214 via an administrator interface server 204. The administrator 214 operates an administrator console 206 that is connected to the administrator interface server 204 via the network 108. The administrator 214 may be a real-money game developer, a lottery provider or any other type of game administrator having the authority to set activity conditions. The gaming incentive platform 112 is adapted to control activity invitations according to the activity condition taking into consideration at least one of a player game data and a player profile data.

In one instance, the activity condition is set to allow only players of a specific group to participate in a gifting system. The activity invitation platform 312 is adapted to send the activity invitation relating to the gifting system only to the players of the specific group as defined by the activity condition, based on the player profile data of the player database 110.

In another instance, the activity condition is set to allow only players having reached a specific score in a game to receive an achievement reward. The activity invitation platform 312 is adapted to send the activity invitation relating to the achievement reward only to the players having reached the specific score as defined by the activity condition, based on the player game data of the player database 110.

According to yet another aspect as presented in FIGS. 2, an administrator 214 monitoring player game data and player profile data of the player database 110 can determine that player engagement and player retention should be increased for a particular game 102 of the system 100 and instruct the activity invitation platform 112 to set an activity condition for the particular game 102 in order to increase player engagement towards the game 102.

A skilled person will understand that the games 102 and/or the activity invitation platform 112 may be installed or partially installed on each console 106 without departing from the scope of the present system.

### Gaming System Development

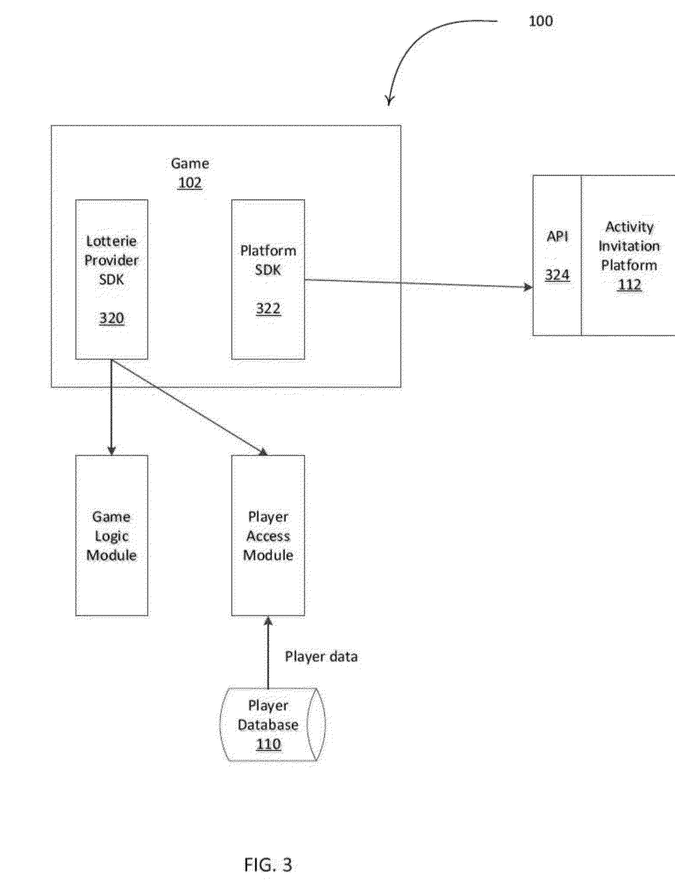

Presented in FIG. 3 is the gaming system 100 from an administrator's perspective. The system 100 includes a real-money game 102 that has been developed and/or configured by a lottery provider Software Development Kit (SDK) 320. The game 102 is adapted to include social features and/or gaming incentive features developed and/or configured via a platform SDK 322. The platform SDK 322 interfaces with an Application Programming Interface (API) 324 that offers various social feature components of and/or gaming incentive feature components of the activity invitation platform 112. With the API 324, developers can integrate social features to a single player type of real-money game in order to transform the game into a social real-money game 102. In addition, the API 324 allows developers to integrate gaming incentive features in a real-money game. The social feature components and gaming incentive feature components can relate to an asynchronous multiplayer module, a friend system module, a progressions system module, a collection system module, a gifting system module, an achievement system module, a leader board system module, a daily spin system module and a virtual economy module.

The asynchronous multiplayer module provides components for developers to integrate an asynchronous play in a real-money game in order to allow a plurality of players to play together in an asynchronous manner. The friend system module provides components to developers for integrating a friend system in a real-money game for allowing a player of a real-money game to play with another player that is a friend or even a stranger. The progressions system module provides components for developers to integrate a progression system in a real-money game for providing to players a linear experience of their progression through difference stages of a real-money game. The collection system module provides components for developers to integrate a collection system in a real-money game allowing players to complete their collection library with virtual goods or other collectible items in order to unlock a new level or map of the game and/or in order to win a monetary reward. The gifting system module provides components for developers to integrate a gifting system in a real-money game allowing players to send each other virtual gifts. The achievement system module provides components for developers to integrate an achievement system in a real-money game to allow lottery providers and/or developers to give out rewards to players that have achieved a certain task or milestone. The leader board system module provides components for developers to integrate a leader board system in a real-money game in order to rank the players. The daily spin system module provides components for developers to integrate a daily spin system in order to give a chance to a returning player to win a virtual or monetary prize. The virtual economy module provides components for developers to integrate a virtual economy in a real-money game in order to give out virtual currency that can be used in a game to purchase virtual goods, upgrades and other virtual items.

It is possible that a combination of activity conditions be set for providing a combination of activity invitations in a same game 102 or in association with a same game 102. Moreover, it is possible that a same activity invitation be used across a variety of games 102 of the system 100.

### Social Conditions—Multiplayer Asynchronous Gaming Information

A multiplayer asynchronous game is a real-money game that allows at least two players to play a same game together in an asynchronous manner. Players are brought together to form opposing or cooperating teams or to pair up for sharing a gaming experience. The teams may be defined by at least one of the players 114 or by an administrator 214 of the system as presented in FIG. 2. When players are brought together to play an asynchronous game together, a co-player is able to compare himself to another co-player and the motivation to achieve a better score than his co-player is increased. As motivation to achieve a better score is increased, the engagement of the co-player towards the game is increased as well. Consequently, each co-player is likely to invest more time in the game and an increase of player loyalty towards the game is achieved, repeated game playing (i.e. replay ability) is thereby promoted. The activity invitation relating to a multiplayer asynchronous gaming information can include an invitation to join the game, an invitation to make a move in an ongoing game, a score or an achievement indication relating to other players, etc.

An activity condition for the activity invitation can be set and the activity invitation platform 112 can be adapted to send out the activity invitation only when the activity conditions are met. According to one embodiment as presented in FIG. 2, an administrator 214 using an administrator console 206 defines with an administrator interface server 204 an activity condition that consists of an association of at least two players. Accordingly, the activity invitation platform 112 sends out an invitation to the at least two players to join the game. If the players accept the invitation, their player profile data is updated in the database 110 to indicate that the players are registered to a same asynchronous real-money game 102. In this particular case, the association of players is registered to play an asynchronous game that resembles the well know battleship game.

The battleship game is a guessing game in which two opposing players secretly arrange on their grid their ships. Each ship occupies a number of consecutive squares on the grid, arranged either horizontally or vertically. The number of squares for each ship is determined by the ship type and the types and numbers of ships allowed are the same for each player. After the ships have been positioned, the game proceeds in a series of rounds. In each round, each player takes a turn to pick a target square in the opponent's grid which is to be shot at. If the square is occupied by an opponent's ship, a hit is indicated to the attacking player and the hit is indicated in a tracking grid for the player to build up a picture of the opponent's fleet. When all the squares of a ship have been hit, the ship is sunk. If all the player's ships have been sunk, the game is over and the opponent wins. Depending on the rules, other variants of the game are possible. The battleship game adapted to a real-money game involves each player to pay out a given amount of money to be authorized to attack the opponent's fleet.

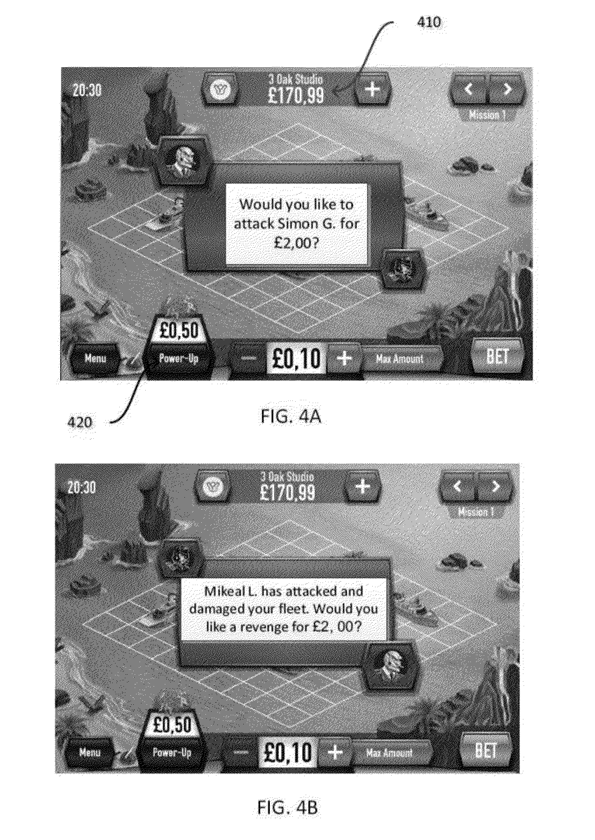

Presented in FIG. 4A, there is a battleship real-money game screenshot taken from a participating player console 106. A winning prize 410 of £170,99 is offered to the first player that succeeds in sinking the whole fleet of his opponent. The screen snapshot indicates that the player 114 is given the opportunity to attack Simon G.'s fleet in exchange of a £2,00 payment. In addition, the player may power up 420 his attack by paying an extra £0.50, which gives the player a chance to make more damage to a ship if the attack results in a ship being hit. A next round of the battleship game from the opponent's console 106 is presented in FIG. 4B, Simmon G. is informed that Mikeal L. has attacked and damaged his fleet, in the same dialog box, Simmon G. is given the opportunity to attack Mikeal L.'s fleet in exchange of a £2,00 payment.

It shall be understood that instead of the administrator 214 of FIG. 2, one of the players 114 may initiate an invitation to play the asynchronous game by connecting to the player interface server 104 and selecting an asynchronous game play option provided by the activity invitation platform 112. The activity invitation platform 112 can then retrieve the associated player profile data from the database 110 and present to the player 114 all connectable players defined in the player database 110 that correspond to a set of predetermined criteria (ex.: all friends of the player) or that correspond to a set of criteria determined by the player (ex.: all members that are part of a specific group such as all members staying at a same hotel). Depending on the game, the player 114 can then select a subset of members or select all members to send them an invitation to join the asynchronous game with the activity invitation platform 112.

It shall also be understood that in an ongoing asynchronous game, a player 114 may initiate an invitation to a next player 114 of the game to make his move in the game. The player database 110 can be adapted to hold an asynchronous game data information with respect to the players 114 that are registered to play a same asynchronous game, such as a current player information and player playing order information. According to the asynchronous game data information, the activity invitation platform 112 can send the invitation to the next player 114.

### Social Conditions—Social Gaming Information

According to another embodiment, a social game (i.e. friend system), such as the above detailed battleship game, allows a player to play a real-money game with another player that is a friend or a stranger. Depending on the social game, playing with another player may or may not have a monetary impact on the player's winnings or odds of winning. The activity invitation relating to social gaming can include an invitation to join the social game or an invitation to follow a players progress. The invitation can include a list of friends that are presently playing the social game. The invitation can include comments from friends or strangers concerning the social game. The invitation can further include a list of achievements for a friend playing the social game.

In one case, the player 114 initiates a social game by inviting another player 114 with the player interface server 104. The player interface server 104 receives from the activity invitation platform 112 all associated friends as defined in the player database 110. The player 114 can then select one of his friends to join the social game in order to play the game together or against each other by setting the activity condition to the selected friend. The activity invitation platform 112 then sends out the activity invitation to that friend as set according to the activity condition.

### Social Conditions—Player Gaming Progress

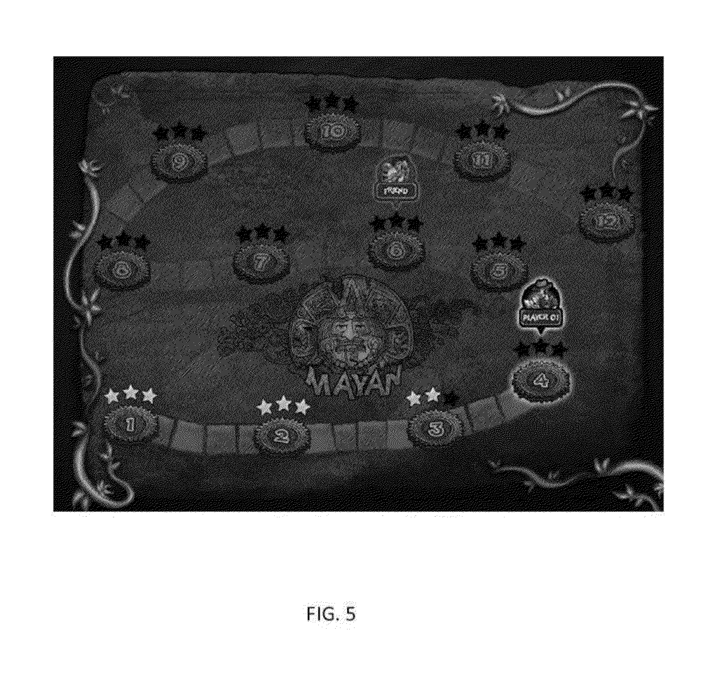

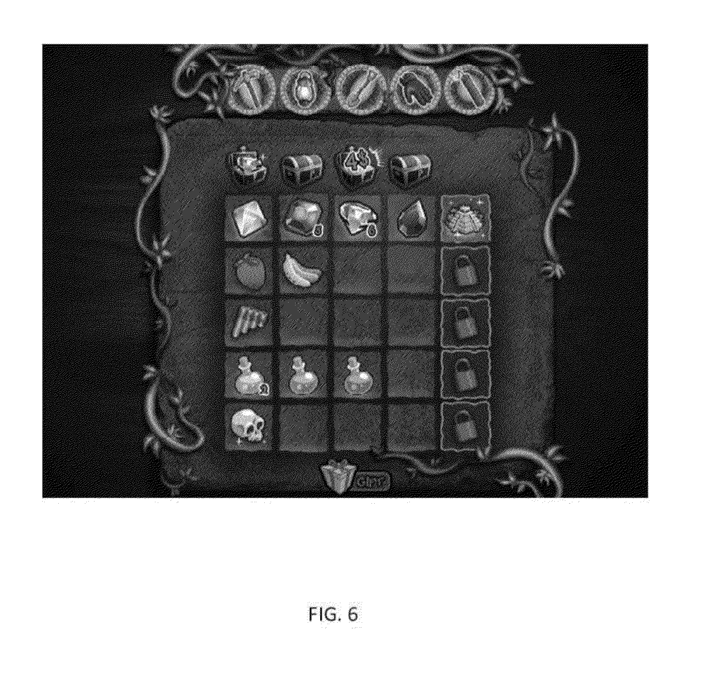

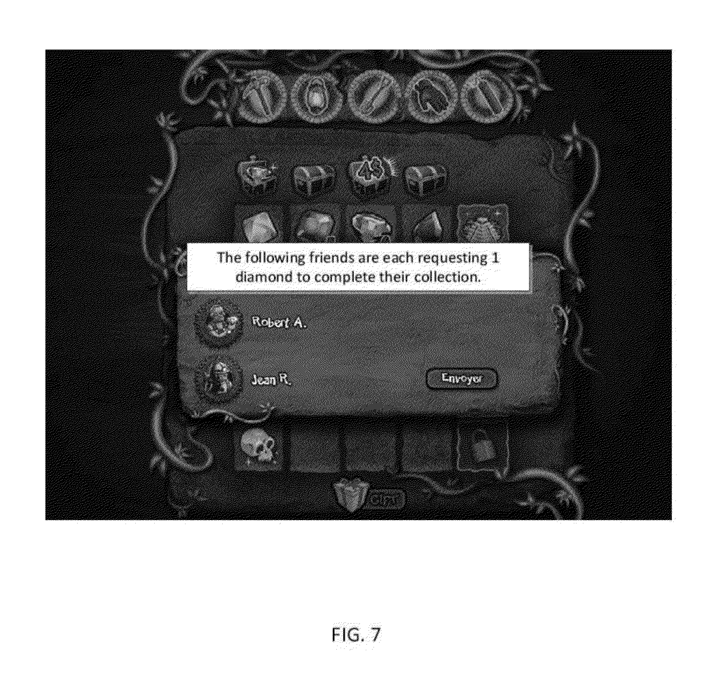

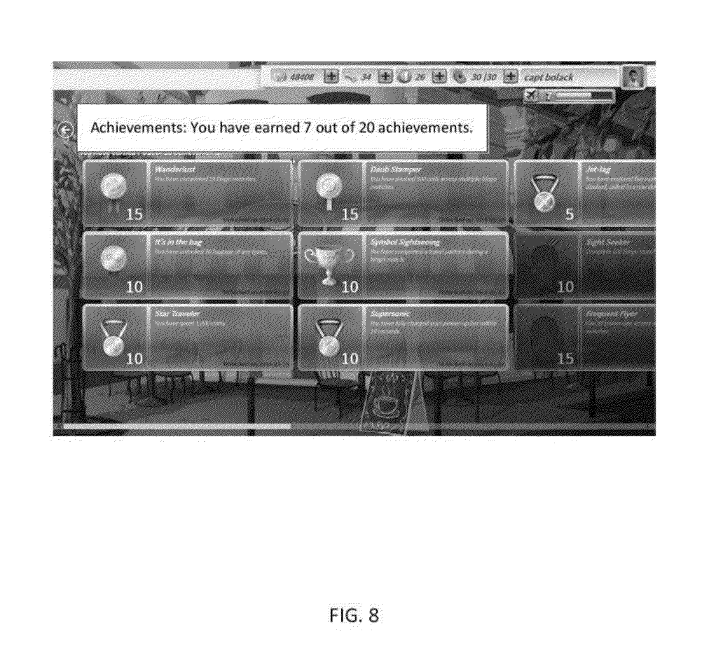

According to yet another embodiment, a player gaming progress allows a player to progress from one stage of a real-money game to another stage in a linear manner without interruption. The activity invitation relating to player gaming progress can include an invitation to follow the player's progression such as by presenting a player progress map, as shown in FIG. 5. The invitation can further include a request to donate or sell an item that the player needs to further progress in the real-money game, as shown in FIGS. 6 and 7. The invitation can also include a list of achievements of the player such as by presenting an achievement chart, as shown in FIG. 8.

By following another player's progression in a game, a player can compare his achievements to the one's of the player he is following. Depending on the gaming context and depending on the player's personality, a player following the achievements of another player may have the desire to perform better than the player he is following or a player following the achievements of another player may have the desire to help the player he is following. An invitation to follow another player drives social aspects of the game and increases player engagement to the game.

In one instance, an activity condition is set to present a player progression map relating to a specific group of players. The activity invitation platform then sends an activity invitation to all the players of that specific group by presenting to them the player progression map.

Presented in FIG. 5 is a player progress map that informs a “player 01” that he has achieved four milestones in the game while a “friend” player has already achieved six milestones. Seeing that the “friend” player is ahead of the “player 01” might encourage the “player 01” to continue playing with the desire of increasing his achievements and be ahead of the “friend”.

### Social Conditions—Gifting System

According to yet another embodiment, a gifting system allows players to send each other virtual gifts that may or may not impact their game play, their winnings or odds of winning. The activity invitation relating to gifting can include requesting a virtual gift or offering a virtual gift. The gift may be requested or offered in exchange of another virtual gift as well.

Presented in FIG. 6 is a collection library associated to a player 114. As shown in the first row of the collection library, the player has collected a series of four different precious stones, as a reward the player is given a prize of four dollars and a diamond stone to add to his collection library. Presented in FIG. 7, the player receives a request from two friends, Robert A. and Jean R. who are requesting one diamond to complete their collection. The supportive player may then respond by gifting two of his diamonds to his friends and encourage them in doing so. As players interact through the game by exchanging, offering, requesting and receiving gifts, the social aspect of the game is emphasized. Moreover, since the players are encouraged and motivated by providing gifts to each other, a viral effect (i.e. virality) of the game is established and increased as the players keep on playing.

In one case, a player needing a specific item makes a request via the activity invitation platform 112 to list the players of his group that have the needed specific item. The activity invitation platform 112 retrieves from the player database 110 the corresponding list of players and presents them to the player via the player interface server 104. The player can then select the players to whom he desires to make the request and set the activity condition accordingly. The activity invitation platform 112 then sends a gift request for that specific item as an activity invitation to each of the selected players via the player interface server 104, according to the previously set activity condition.

In one case, a player receives a gift from another player via the activity invitation platform 112. The activity invitation platform 112 receives from the player interface server 104 a request to transfer a gift from one player to another player and updates accordingly the player profile data of both players in the player database 110.

Social Conditions—Leader board System

According to yet another embodiment, a leader board presents a ranking of players in a real-money game based on a single or group of predetermined criteria. The ranking of a player may or may not influence a monetary or virtual gain. The activity invitation relating to leader boards includes an invitation to join a leader board and a presentation of a ranking in the leader board.

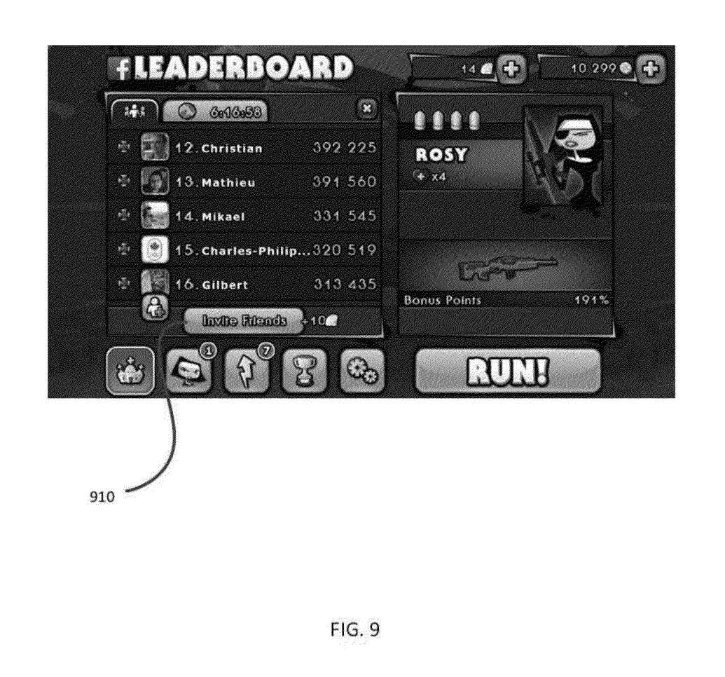

In one game, the leader board allows a player to compare his results to the results of other players according to a predetermined set of criteria such as: the number of victories, defeats, points, etc. In one game, the leader board presents to the player the results of a weekly tournament. Presented in FIG. 9 is a screenshot of a player console displaying a leader board. The leader board presents to the player all other players playing the same weekly tournament and their respective accumulated points. As can be noticed, an invite friends button 910 allows the player to invite other friends of the game to join the leader board and have his results displayed on the players leader board. The invitation can be a mutual invitation whereby both inviter and invitee are each added to their respective leader boards. Since players are able to compare themselves with other players, players can be motivated to increase their performance and continue playing thereby increasing player replay ability and player engagement towards the game.

In one case, the activity condition is set to select a top ten player list for a specific game. Accordingly, the activity invitation platform 112 selects a list of top ranking players of the game based on the player game data in the player database 110. The activity invitation platform 112 sends an invitation to the selected players for joining the leader board via the player interface server 114.

In one case, a player 114 receives an invitation via the player interface server 114 to join the leader board for a particular game. The player 114 accepts the invitation by sending his acceptance to the activity invitation platform 112 via the player interface server 104. The activity invitation platform 112 receives the acceptation from the player and updates the corresponding player game data of the player database 110.

In one case the activity invitation platform 112 receives a request from a player via the player interface server 104 to view a leader board associated for a specific game. The activity invitation platform 112 retrieves the corresponding player game data from the player database 110 and presents to the player the requested leader board via the player interface server 104.

### Gaming Incentive Conditions—Collection Libraries

According to one embodiment, a player can try to fill up his collection library with virtual goods or other collectible items, in order to unlock a new map or a new level in the real-money game or to obtain a monetary reward. The activity invitation relating to collection libraries includes receiving a chance to obtain a missing collection library item. The invitation condition can be set to sending the activity invitation according to a specific in-game performance of the player or when a player has achieved a specific score in the game.

In one game, in-game performance is rewarded with virtual goods to fill up a collection library, as presented in FIG. 6. As shown in the first row of the collection library, the player has collected a series of four different precious stones, as a reward the player is given a prize of four dollars and a diamond stone to add to his collection library. As the player earns or receives items to insert into his collection library, the player's engagement in the game increases and player retention is thereby achieved.

### Gaming Incentive Conditions—Achievement Rewards

According to another embodiment, the activity invitation relating to achievement rewards includes a reward given to a player for his skills or good action in the game. The reward may be a virtual good or real-money. In one game, the invitation condition is set to sending a reward when a player achieves a specific milestone or a group of milestones in the game. This way, the player receives a reward when he achieves the predetermined milestone or the group of predetermined milestones in the game. The achievement rewards increase player motivation and engagement to the game thereby increasing player replay ability and player retention.

Presented in FIG. 8 is a screen snapshot of achievement rewards that a player has collected during a game. According to this snapshot, the player has so far successfully earned seven out of twenty achievement rewards and thirteen other achievement rewards are yet to be earned. Viewing his achievements, the player can be motivated to keep on playing in order to earn more achievement rewards.

### Gaming Incentive Conditions—Daily Spin Rewards

According to yet another embodiment, the activity invitation relating to daily spin includes rewarding the player for coming back to play a game on a daily basis with a bonus game of chance. The activity condition can be set to a daily game login frequency for a player. In one instance, when a player logs into a same game for at least two consecutive days the activity condition is met and the player receives a bonus game. The bonus game offers the player a chance to win virtual goods or virtual currency. A skilled person will recognise that the daily spin may be replaced by a weekly spin or any other type of bonus game of chance that can quickly and easily be played by a returning game player for enhancing player retention.

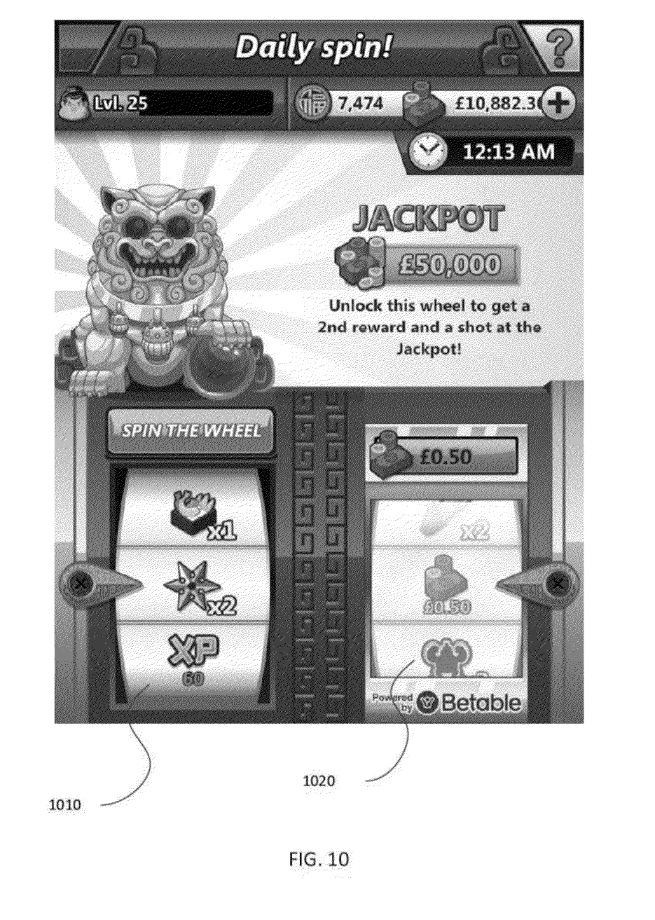

Presented in FIG. 10 is a bonus game of chance that is offered to a returning player, in this case the game of chance is a daily spin. The player is given the chance to spin a first wheel 1010 and win a virtual good or virtual currency. In this example, the player is also offered to unlock a second wheel 1020 by paying £0.50 to get a second reward and a shot at the Jackpot of £50,000.

### Cross Game Promotion

The activity invitation described in the above embodiments may correspond to information related to a plurality of games and provide cross game promotion. For instance, the player gaming progress information of FIG. 5 can represent player gaming progress of a plurality of games 102 provided by the system 100. In another instance, the collection library information can be associated to a plurality of games 102 provided by the system 100. A player can be offered a chance to collect an item for adding to his collection library when he achieves a milestone in any one of the games 102 of the system 100. In yet another instance, the leader board information can be associated to a plurality of games 102 provided by the system 100. The leader board can include combined player ranking information relative to a plurality of games. Moreover, the daily spin can be offered when a player logs into any one of a group of games provided by the system, on a daily basis.

What is claimed:

1. A real-money gaming system comprising:
a player database adapted to store at least a player game access control data, a player game data and a player profile data with respect to each of a plurality of players registered to play at least one real-money game with a player console via a network;
an activity invitation platform adapted to generate an activity invitation according to an invitation condition and at least one of the player game data and the player profile data; and
a real-money game application being adapted to execute the at least one real-money game according to the activity invitation.

2. The real-money gaming system of claim 1 further comprising an administrator interface server connected to the activity invitation platform and adapted to allow an administrator to define an invitation condition.

3. The real-money gaming system of claim 1 further comprising a player interface server adapted to provide the at least one real-money game to the player console in accordance with the activity invitation.

4. The real-money gaming system of claim 2 further comprising a player interface server adapted to provide the at least one real-money game to the player console in accordance with the activity invitation.

5. The real-money gaming system of claim 3 wherein the player interface server is adapted to allow a player to define an invitation condition.

6. The real-money gaming system of claim 4 wherein the player interface server is adapted to allow a player to define an invitation condition.

7. An activity invitation platform adapted to receive from a player database a player game data and a player profile data with respect to each of a plurality of players registered to play at least one real-money game, the activity invitation platform being adapted to generate an activity invitation according to an invitation condition, the player game data and the player profile data, in order to allow a real-money game application to execute the at least one real-money game according to the activity invitation.
